(19) United States
(12) Patent Application Publication
(10) Pub. No.: US 2006/0066563 A1
(43) Pub. Date: Mar. 30, 2006

(54) Finger-mounted instrument

(76) Inventor: Don Mochwart, Port Washington, NY (US)

Correspondence Address: KEUSEY, TUTUNJIAN & BITETTO, P.C., 20 CROSSWAYS PARK NORTH, SUITE 210, WOOBURY, NY, 11797, US

(21) Appl. No.: 10/949,692

(22) Filed: Sep. 24, 2004

(51) Int. Cl. G09G 5/00

(52) U.S. Cl. 345/156

(57) ABSTRACT

A finger-mounted instrument comprising a sheath for fitting onto a fingertip, the sheath having at least one node and a protruding element removably affixed onto said at least one node. The protruding element is detachable and includes a cavity therein for receiving the node for attachment. In one embodiment, a partial-sheath is provided for covering the underside of a finger, the partial-sheath having at least one strap for fastening onto a finger and at least one node disposed on the underside of one end of the partial-sheath. In another embodiment, a full-sheath is provided for covering the entire tip of a finger, is freely rotatable and has at least one node, with at least one protruding element removably attached onto said at least one node.

### BACKGROUND OF THE INVENTION

1. Technical Field

The present invention relates generally to finger-mounted instruments, and more specifically, to a portable finger-mounted multi-functional data entry device comprising at least one protruding element adjustably attached to the underside of a human fingertip.

2. Description of Related Art

With the recent proliferation of personal digital assistants (“PDA's”) and wireless handheld devices and in particular, PDA's having keyboards and touch screens, it is well-known that data entry is a requisite and fundamental part of effective use and enjoyment of such devices. Indeed, PDA's have proven to be extremely useful for organizing tasks, keeping track of schedules and storing information, all of which depend on the user's accurate entry of data.

During the PDA's infancy, devices which included handwriting recognition capability began to appear. Data entry typically involved either: 1) entering information on a desktop personal computer (“PC”) and then synchronizing the data into the PDA, or 2) manually inputting information directly into the PDA.

To facilitate data entry, PDA's typically include a separate elongate pen-shaped writing utensil or “stylus” with a non-marking tip which is used to enter data by, for example, tapping key by key on the PDA display screen (e.g., an on-screen QWERTY keyboard) or alternatively, to handwrite the desired entry letter by letter onto an allocated drawing space on the PDA. The stylus also served as a pointer that could be used to enter anything “clickable” (e.g., icons) on the touch screen display.

However, data entry using a stylus is often cumbersome, tedious and time-consuming. Moreover, many people find it difficult to grip and handle styluses, with their necessarily narrow shape and small size (to facilitate portability) especially for long periods of time.

Arthritis and chronic joint symptoms affect nearly 70 million Americans, or about one out of every three adults, making it one of the most prevalent diseases in the United States. As the population ages, this number will increase dramatically. For those afflicted with arthritis, chronic joint problems or carpal tunnel syndrome and those who are otherwise handicapped, e.g., having lost one or more digits, the stylus is even more of a challenge and even painful or impossible to use.

To compound the challenge of data entry, as PDA's began to evolve, web-enabled versions began to emerge. Many PDA's now offer wireless internet access for sending and receiving E-mail as well as the ability to access information from the web. For example, the BlackBerry® handheld enables users to perform many tasks traditionally performed on a desktop/laptop computer (e.g., includes internet and World Wide Web capabilities) on a portable handheld unit. In addition, portable versions of software such as Microsoft Word™ and Excel™ became available for use with these PDA's. As such, there emerged an increased need by users to enter larger and larger amounts of data into their PDA's, e.g., in composing E-mail messages, conducting instant messaging and surfing the web.

To address this need, the BlackBerry® included an actual keypad, which was meant to facilitate typing. Other PDA's typically began to include keypads as well. However, PDA manufacturers were then presented with the dilemma of weighing the benefits of the inclusion of a keypad with its disadvantages, as the keypad conflicted directly with one of the fundamental advantages of the PDA: its portability. Often, some of the PDA's portability was sacrificed, e.g., the device was made longer overall to accommodate the keypad. In attempts to maximize portability, the keypad was made as compact as possible; however, typing on such keypads was often riddled with mistakes due to the small keys and was no more user-friendly for handicapped and/or arthritic individuals.

In other cases (such as in the Treo™ from PalmOne™) the screen size was sacrificed to allow for the keypad. However, such reduction in screen size conflicted directly with the PDA's new web capability, as users who were seeking a PDA having wireless or Bluetooth capability were primarily interested in the web experience, and reducing the size and resolution of the screen wholly diminishes the nature of the web experience.

Other attempts to solve the problem include foldable keyboards, keyboards that rolled up and keyboards that had a synching device integrated into its design. However, all such accessories failed to address and maintain the PDA's portability and moreover made no efforts to facilitate data entry for arthritic/handicapped individuals. Indeed, requiring a user to carry a foldable keyboard in addition to the PDA itself markedly reduced its convenience and portability. Users often found that carrying around the folding keyboard, setting it up, finding a surface to type on, etc. was no more convenient than simply using their desktop/laptop PC's for data entry.

Some manufacturers have tried to completely redesign the PDA so that the keypad is concealed in attempts to address both portability and retain screen size and resolution. However, a main drawback to such devices is price; such overhauls in design is costly for manufacturers and results in an expensive PDA product for the consumer.

Thus, the prior art has failed to provide a truly convenient, portable, cost-effective means for data entry into handheld devices, namely PDA's. Moreover, none of the manufacturers have addressed the needs of arthritic or handicapped PDA users.

Accordingly, an efficient and effective instrument for facilitating data entry into, e.g., a handheld device conveniently, effectively and inexpensively, and in particular, a instrument which is easily usable by individuals with physical limitations, is highly desirable.

### SUMMARY OF THE INVENTION

The present invention is directed to an instrument for facilitating data entry into, e.g., a portable handheld device. Advantageously, a device according to the present invention not only emphasizes portability and cost-effectiveness, but provides adaptability, is ergonomic and vastly improves ease of use and data entry accuracy for all individuals and especially those with physical limitations, e.g., of the hands and fingers. Indeed, use of the finger-mounted instrument according to the present invention does not require a great deal of muscular action (i.e., physical gripping of the instrument by the user is unnecessary).

Further, the present invention provides advantages to the PDA manufacturer, since it avoids the need to completely redesign the PDA to accommodate, e.g., a bigger or otherwise better keypad, and instead allows manufacturers to re-focus on portability, improved screen size, etc. As a result, manufacturers are no longer forced to compromise either portability or screen size.

Likewise, the present invention is appealing to consumers since it offers a low-cost yet effective and ergonomic solution for facilitating convenient inputting of data into, e.g., a PDA with improved accuracy, whether by writing, tapping on screen icons or typing, that is further adaptable and customizable by each user according to each user's desired method of data entry, typing/writing position and/or various finger sizes.

According to an aspect of the present invention, a finger-mounted instrument is provided comprising a sheath for mounting onto a user's fingertip, the sheath having a first and second end and at least one node disposed at an outer surface of the first end thereof. At least one protruding element is provided for removable attachment to said at least one node.

In another aspect, a finger data entry device is provided comprising a sheath for attachment to a fingertip, the sheath having a first and second end and a plurality of nodes disposed at said first end. A protruding element is provided removably attached to at least one of said plurality of nodes.

In yet another aspect of the present invention, a thumb-mounted data entry instrument is provided comprising a sheath for mounting onto a user's thumb-tip, the sheath having a first and second end and at least one node disposed at an outer surface of the first end thereof. At least one protruding element is provided removably attached to said at least one node.

These, and other aspects, features and advantages of the present invention will be described or become apparent from the following detailed description of the preferred embodiments, which is to be read in connection with the accompanying drawings.

### BRIEF DESCRIPTION OF THE DRAWINGS

FIG. 1 is an exemplary illustration of a perspective view of a finger-mounted instrument 100 having nodes 107 according to an embodiment of the present invention.

FIG. 2 depicts an exemplary illustration of a perspective view of a finger-mounted instrument fastened onto a user's finger according to an aspect of the present invention.

FIG. 3 is an exemplary bottom view of the finger-mounted instrument 100 according to an aspect of the present invention.

FIG. 4 depicts an exemplary perspective view of a protruding element according to an aspect of the present invention.

FIG. 5 is an exemplary perspective view of a finger-mounted instrument 500 according to another embodiment of the present invention.

FIG. 6 depicts an exemplary illustration of a perspective view of a finger-mounted instrument according to another embodiment of the present invention fastened onto a user's finger.

FIG. 7 depicts an exemplary illustration of the finger-mounted instrument 500 fastened onto a user's thumb to facilitate data entry into a PDA device according to an aspect of the present invention.

### DETAILED DESCRIPTION OF PREFERRED EMBODIMENTS

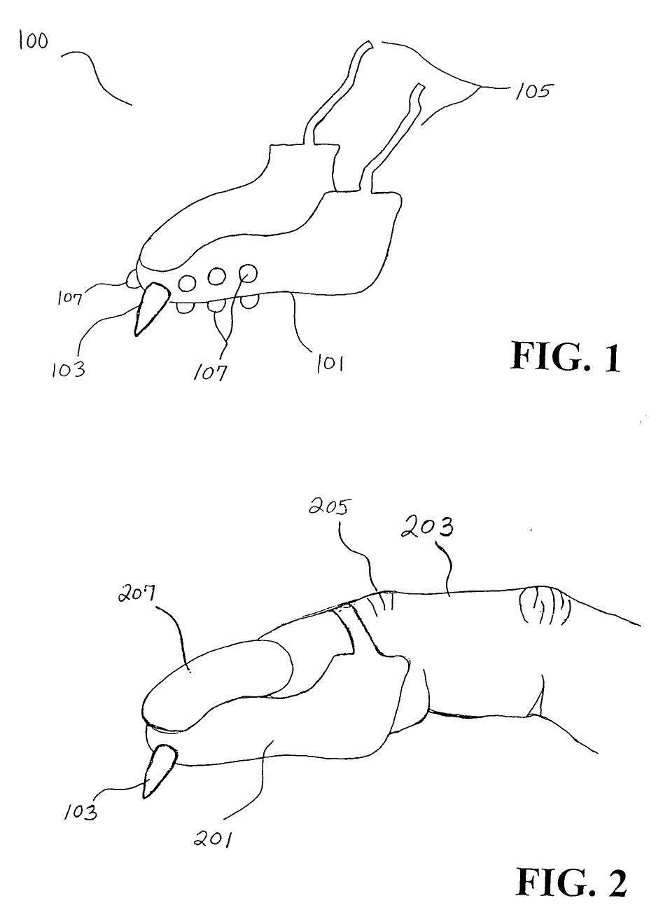

Referring now to the Figures, the illustration of FIG. 1 depicts a perspective view of a finger-mounted instrument 100 according to an embodiment of the present invention. In this embodiment, the instrument 100 comprises a partial-sheath 101 which preferably covers at least the bottom of a user's finger (“fingerpad”) between the fingertip up to the distal interphalangeal joint 205 (see FIG. 2). This prevents interference with the bending action of the finger joints. The partial sheath 101 may additionally partially cover the sides of the user's fingertip as shown, e.g., in FIG. 2. The partial-sheath 101 preferably leaves the nail bed 207 of the finger exposed, which facilitates use of the instrument by those with, e.g., long fingernails.

The partial sheath 101 further comprises at least one strap 105 preferably secured at a top side of a second end thereof (see FIG. 1) such that the strap is able to be wrapped around the top of a user's finger 203 during fastening (see FIG. 2). Each strap 105 includes a fastening means located at distal ends thereof, preferably a hook and loop type fastener (e.g., Velcro®) for securing the instrument 100 to a finger. The strap 105 may be comprised of any flexible material (e.g., cloth, rubber, vinyl, etc.) and may also be elasticized.

In the exemplary embodiment as shown in FIG. 1, two straps 105 are shown. It is to be noted that a single strap embodiment may be contemplated, with any fastening means (e.g., buckle system, Velcro™, etc.) utilized/re-situated accordingly to provide effective attachment of the instrument 100 to the user's finger.

The partial-sheath 101 is preferably comprised of a flexible material e.g., rubber, cloth, leather, plastic, vinyl, foam, etc., or any multi-layered combinations of same (e.g., cloth-lined rubber) and is preferably between about 1.5 cm to about 3.0 cm in length, although other lengths may be contemplated and/or a range of sheath-length sizes may be provided. Preferably, a range of sizes is provided to provide customized fitting and to prevent the partial-sheath 101 from interfering with the joint action of the finger to which it is attached; preferably the partial-sheath 101 is fitted so that it does not extend beyond the distal interphalangeal joint 205 as discussed above.

The partial-sheath 101 includes a protruding element 103 attached at a bottom side of a first end thereof. In a preferred embodiment, the protruding element 103 is removably attached to the partial-sheath 101; however, the protruding element 103 may instead be integrally formed with the partial-sheath 101 and thus be permanently affixed thereon.

The protruding element 103 preferably comprises an elongate structure having a tip to facilitate e.g., tapping keys and/or writing on a touch screen, and is preferably comprised of a rigid material such as plastic, rubber, metal, etc. The tip 405 (see FIG. 4) may comprise a non-marking tip or alternatively, a tip adapted for marking via ink, marker, pencil lead, crayon, etc. to provide writing, namely “finger-writing” capability on e.g., paper.

The protruding element 103 may be provided in various shapes, lengths and/or thicknesses as per its intended use. In a preferred embodiment, the protruding element 103 is at least 0.25 cm in length. The tip 405 may be “cone-shaped” or pointed to facilitate, e.g., typing accuracy on small keypads and/or writing fine lines on a touch screen. Alternatively, the tip 405 may be of a blunted shape (e.g., shaped to have a larger surface area) to facilitate e.g., keyboard typing. In the non-marking embodiment, the tip 405 may be comprised of a material having a relatively high frictional coefficient (e.g., rubber) to reduce slipping during e.g., typing, or a low frictional coefficient (e.g., Teflon™, polycarbonate, etc.) to facilitate, e.g., writing on a touch screen. Alternatively, the tip 405 may be comprised of a material having any desired frictional coefficient to facilitate, for example, a multi-purpose use (e.g., both typing and touch-screen writing).

Advantageously, the protruding element 103 is removable and interchangeable with other protruding elements having, e.g., different tips 405. Thus, the user may alternate between any of a variety of protruding elements 103 as desired to switch e.g., between tips adapted for different uses (writing via ink/pencil lead/markers, keypad typing, touch-screen writing, etc).

As shown in FIG. 4, the protruding element 103 preferably includes a cavity 403 located at its base 401 adapted for receiving a node 107 to removably affix the element 103 onto the partial-sheath 101.

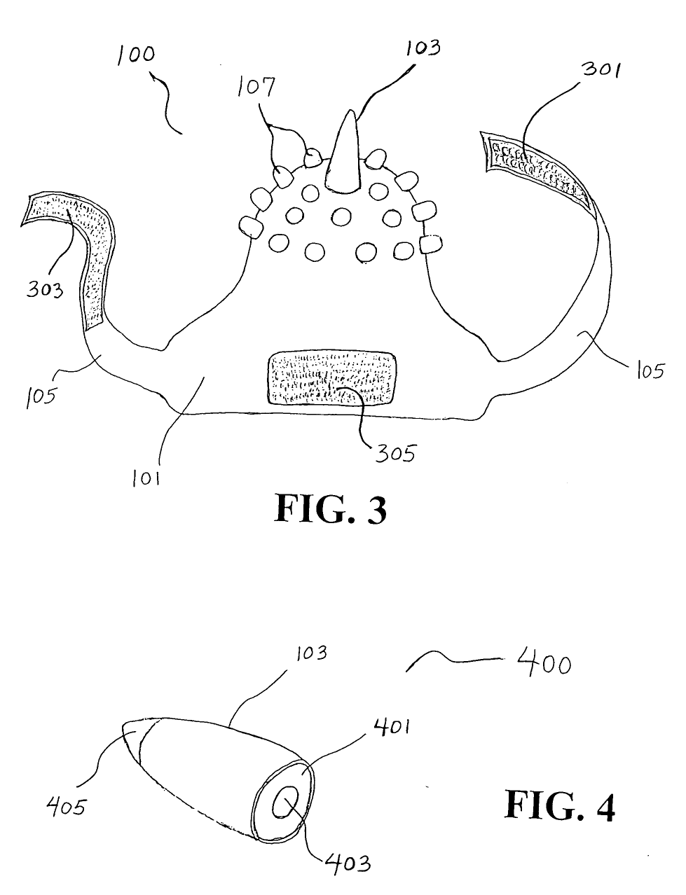

The partial sheath 101 preferably includes a plurality of nodes 107 attached to and jutting from various locations of the outer surface at one end (the “fingertip” end). FIGS. 1 and 3 provide exemplary illustrations of the location and distribution of the nodes 107. The nodes 107 provide customizability in the placement of the protruding element 103, and are adapted to be received within the cavity 403 of the protruding element 103 to secure same onto the partial-sheath 101. The mating of a node 107 with a protruding element 103 may be achieved via, e.g., frictional coupling, suction, snap-fit, etc.

The varied placement of the nodes 107 on the partial-sheath 101 provides multiple attachment points for the protruding element; since the partial-sheath 101 has a curved surface, such varied node distribution also provides for user placement of the protruding element 103 at multiple angles relative to the partial-sheath 101. Also, the protruding element 103 may be repeatedly attached and detached by the user from the nodes 107 as desired. Advantageously, the present invention provides the user with the ability to adjust the location of the protruding element quickly and easily as desired (e.g., in accordance with how the finger-mounted instrument is to be used).

The illustrated location and number of nodes 107 as shown in FIGS. 1 and 3 are for exemplary purposes only and other node configurations/quantities are contemplated. It is to be noted that FIG. 2 depicts an exemplary illustration of a “node-less” partial-sheath 201 attached to a finger 203 according to yet another embodiment of the present invention. FIG. 3 is a bottom view of the instrument 100 of FIG. 1, showing the distributed nodes 107 at one end of the underside of the partial-sheath 101. The protruding element 103 is shown attached at one of the nodes 107 for exemplary purposes only; as discussed above, the element 103 may be attached at any of the other nodes 107 as desired. Each strap 105 preferably further includes fasteners 301 and 303 (e.g., Velcro®) for securing the instrument to a finger as discussed above with reference to FIG. 1.

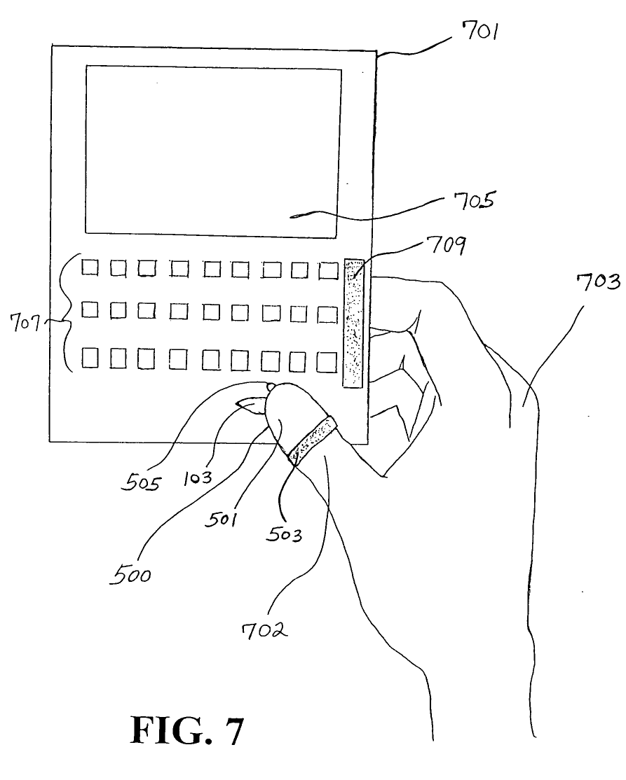

FIG. 3 depicts an embodiment wherein the partial-sheath 101 may include an additional fastening patch 305 (e.g., Velcro®) for securing the instrument 100 onto a reciprocal fastening patch on another object (e.g., a PDA, cell phone, calculator, etc.) for storage, as further described with reference to FIG. 7 below. The fastening patch 305 may be located at any position on the finger-mounted instrument 100; its location as depicted in FIG. 3 is for exemplary purposes only.

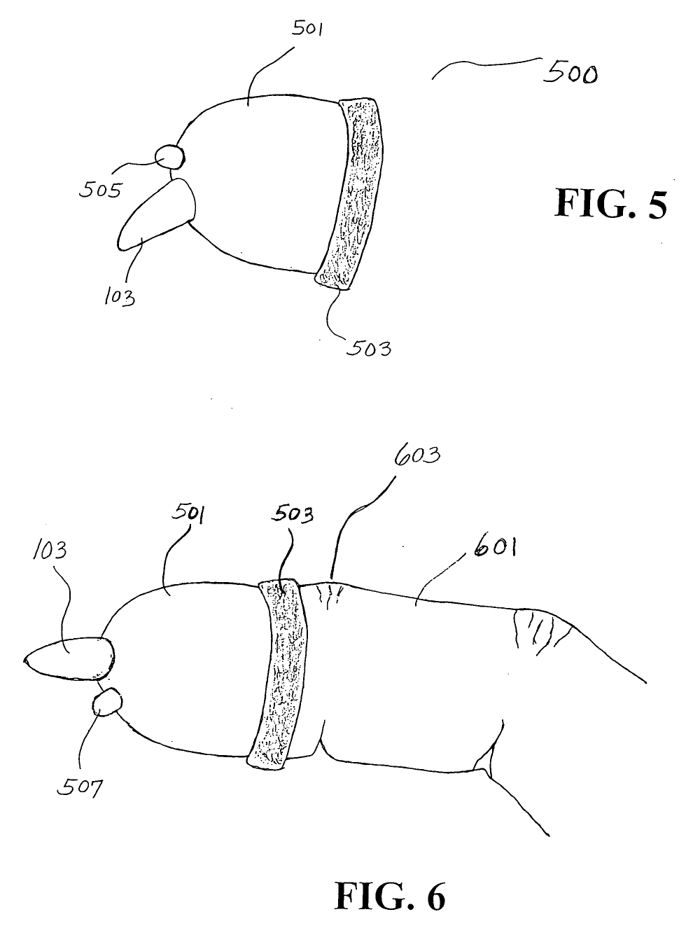

FIG. 5 depicts a perspective view of a finger-mounted instrument 500 according an another embodiment of the present invention, wherein a full-sheath 501 is provided for fully covering the end of a human fingertip. The full-sheath 501 preferably covers the entire fingertip surface (i.e., bottom, top and sides) up to but not beyond the distal interphalangeal joint 603 (see FIG. 6). This prevents interference with the bending action of the finger joints.

The full-sheath 501 is preferably comprised of a flexible material e.g., rubber, cloth, leather, plastic, vinyl, foam, etc., or any multi-layered combinations of same (e.g., cloth-lined rubber) and is preferably between about 1.0 cm to about 2.5 cm in length, although other lengths and/or a range of sizes may be contemplated. This provides a custom fit for preventing the full-sheath 501 from interfering with the joint action of the finger.

The full-sheath 501 may be provided in various diameters for snug attachment to different finger sizes. In addition, elastic material may be used/incorporated to facilitate and/or improve a snug fit.

In FIG. 5, the protruding element 103 is shown attached to a first end of the full-sheath 501 at an off-center node 507 (see FIG. 6 for off-center node 507). Preferably, at least one other node is provided (e.g., a center node 505) so that the element 103 may instead be attached on such center node 505 when an alternate configuration is desired. In a preferred embodiment, the protruding element 103 is removably attached to the full-sheath 501 via e.g., the nodes 505 or 507; however, the protruding element 103 may instead be integrally formed with the full-sheath 501 and thus be permanently affixed thereon.

FIG. 6 shows the instrument 500 having the protruding element 103 attached onto the center node 505, and additionally shows the instrument 500 attached onto a user's finger 601. It is to be noted that any number of additional nodes 107 may be provided on the full-sheath 501 in any location to provide further options/locations for positioning of the protruding element 103.

The full-sheath 501 further includes an external fastening strip 503 (e.g., a hook and loop fastener) preferably located along the entire outer circumference of a second end thereof for securing the instrument 500 to another object (e.g., as explained further with reference to FIG. 7 below).

Advantageously, the full-sheath embodiment (e.g., as shown in FIGS. 5 and 6) is fully rotatable while on the user's finger which in turn permits full rotation of the protruding element 103 relative to the finger 601. When affixed on the off-center node 507 (e.g., as shown in FIG. 5), the protruding element 103 may thus be rotated to any of a number of different positions relative to the user's finger, thus providing quick and easy adjustment of the protruding element's position relative to the finger.

It is to be noted that either the partial-sheath embodiment (e.g., as depicted in FIG. 1) or the full-sheath embodiment (e.g., as shown in FIG. 5) may be used on any finger (e.g., index finger, thumb, middle finger, etc.). The partial-sheath 101 and the full-sheath 501 each may be molded/contoured to fit the shape of specific or various fingertips. Also, multiple finger-mounted instruments may be used concurrently and may be attached to fingers of either or both hands. When mounted on the thumb-tip, either the partial-sheath or full-sheath embodiments according to the present invention preferably do not extend beyond the interphalangeal joint of the thumb to prevent from interfering with thumb mobility and range of movement.

Advantageously, use of a finger-mounted instrument according to any embodiment of the present invention on the thumb(s) facilitates, e.g., typing and/or touch-screen writing with one or both thumbs. “Thumb-typing” typically requires a different angular position of the protruding element 103 relative to the thumb, which is easily achieved using the finger-mounted instruments of the present invention by virtue of the adjustability of the location of the protruding element 103 relative to the finger (e.g., the plurality of nodes 107 in the partial-sheath embodiment and the rotatability of the full-sheath embodiment while the protruding element 103 is attached on the off-center node 507 provide for user-controlled adjustability in the positioning of the protruding element 103).

FIG. 7 depicts an illustration of the finger-mounted instrument 500 fastened onto a user's thumb 702 according to an aspect of the present invention to facilitate data entry into, e.g., a PDA device 701. The PDA device 701 preferably includes a display screen 705, a keypad 707, and at least one device fastening patch 709. In the exemplary illustration shown, at least one user's hand 703 grips the PDA 701 and either or both of the user's thumbs 702 having the finger-mounted instrument 500 attached thereon may be used for e.g., “thumb-typing” onto the keypad 707 and/or entering data using the screen 705 via e.g., “touch-screen” writing and/or tapping of display icons.

Alternatively, the finger-mounted instrument 100 may be used here instead of or in addition to the instrument 500. When the finger-mounted instrument 100 or 500 is not in use, it may be attached for storage directly onto the PDA 701 via contacting the external fastening strip 503 or fastening patch 305 with device fastening patch 709. Advantageously, this prevents loss or unwanted separation of the instrument 100 or 500 from the device with which it is used with.

Additional or alternate fastening patches 709 may be disposed on the PDA 701 at any location thereon and in any configuration. Also, the configuration of the PDA 701 is for exemplary purposes only and alternate configurations are contemplated. Any device which has a keypad and/or a touch screen (e.g., cell phones, calculators, etc.) may be used in conjunction with the finger-mounted instrument of the present invention. Any device used in conjunction with the finger-mounted instrument of the present invention may include a fastening patch 709 in any location thereon.

Although illustrative embodiments of the present invention have been described herein with reference to the accompanying drawings, it is to be understood that the invention is not limited to those precise embodiments, and that various other alterations, modifications and improvements may be affected therein by one skilled in the art. Such alterations, modifications and improvements are intended to be within the scope and spirit of the present invention. Accordingly, the foregoing description is by way of example only and is not intended to be limiting. This invention should be limited only by the claims and equivalents thereof.

What is claimed is:

1. A finger-mounted instrument comprising:
a sheath for mounting onto a user's fingertip, the sheath having a first and second end and at least one node disposed at an outer surface of the first end thereof; and
at least one protruding element for removable attachment to said at least one node.

2. The instrument of claim 1, wherein the protruding element includes a cavity therein adapted for receiving the node for removable attachment.

3. The instrument of claim 1, wherein the sheath includes a fastening patch for securing the instrument to another object for storage.

4. The instrument of claim 3, wherein the object comprises at least one of a PDA, cell phone or calculator.

5. The instrument of claim 1, wherein the protruding element includes a marking tip for writing.

6. The instrument of claim 1, wherein the protruding element includes a non-marking tip.

7. The instrument of claim 6, wherein the non-marking tip is comprised of a material having a high frictional coefficient to facilitate typing.

8. The instrument of claim 6, wherein the non-marking tip is comprised of a material having a low frictional coefficient to facilitate touch-screen writing.

9. The instrument of claim 1, wherein the sheath comprises a partial sheath for covering at least the bottom of the finger between the fingertip and a distal interphalangeal joint.

10. The instrument of claim 8, wherein the partial sheath includes at least one strap attached at the second end thereof for wrapping around the finger to secure said instrument to the finger.

11. The instrument of claim 1, wherein the sheath comprises a full sheath for covering an entire surface of the fingertip up to a distal interphalangeal joint.

12. A finger data entry device comprising:
a sheath for attachment to a fingertip, the sheath having a first and second end and a plurality of nodes disposed at said first end; and
a protruding element removably attached to at least one of said plurality of nodes.

13. The device of claim 12, wherein the protruding element includes a cavity therein adapted for receiving at least one node for removable attachment.

14. The device of claim 12, wherein the protruding element includes a marking tip for writing.

15. The device of claim 12, wherein the protruding element includes a non-marking tip.

16. The device of claim 12, wherein the sheath comprises a partial sheath for covering at least the bottom of the finger between the fingertip and a distal interphalangeal joint.

17. The device of claim 16, wherein the partial sheath includes at least one strap attached at the second end thereof for wrapping around the finger to secure said instrument to the finger.

18. The device of claim 12, wherein the sheath comprises a full sheath for covering an entire surface of the fingertip up to a distal interphalangeal joint.

19. A thumb-mounted data entry instrument comprising:
a sheath for mounting onto a user's thumb-tip, the sheath having a first and second end and at least one node disposed at an outer surface of the first end thereof; and
at least one protruding element removably attached to said at least one node.

20. The instrument of claim 19, wherein the sheath comprises a partial sheath for covering at least the bottom of the thumb between the thumb-tip and an interphalangeal joint.

21. The instrument of claim 19, wherein the sheath comprises a full sheath for covering an entire surface of the thumb-tip up to an interphalangeal joint.
